(19) United States
(12) Patent Application Publication
(10) Pub. No.: US 2006/0282642 A1
(43) Pub. Date: Dec. 14, 2006

(54) PC-connectivity for on-chip memory

(76) Inventor: Colin Garlick, Northampton (GB)

Correspondence Address: TEXAS INSTRUMENTS INCORPORATED, P O BOX 655474, M/S 3999, DALLAS, TX, 75265, US

(21) Appl. No.: 11/370,127

(22) Filed: Mar. 7, 2006

(30) Foreign Application Priority Data
Mar. 7, 2005 (GB) 504658.6

(51) Int. Cl. G06F 12/00

(52) U.S. Cl. 711/173; 711/103

(57) ABSTRACT

An integrated microcontroller on-chip memory that is an erasable non-volatile memory. It has a first portion that contains re-connection stub code for connecting the memory to a host computer when the memory is connected to the host computer either via a serial port of the host computer or via a connection media that mimics a serial port. It has a second portion that contains application code. It has a third portion that contains data that is accessible to said host computer when the host computer is connected to the memory.

This invention relates to access to integrated microcontroller on-chip memory devices, for example, access to on-chip flash memory of products such as consumer electrical and electronic products and industrial products.

### BACKGROUND

Many electrical and electronic systems allow for re-configuration of parts of the system. Such re-configuration may be required by a development engineer during the development of a product. Also, such access may be required by a service engineer and in many cases; end-users would like to have such access to enable them to customize such devices, and also to carry out tasks such as upgrading software. Particularly in relation to service engineers, providing such access remotely so that the service engineer does not need to visit the location of the product would be advantageous.

There are many examples of applications that would benefit from increased access. A non-exhaustive list of is given below.

Home central heating systems typically include simple timer circuits to allow a user to set the times at which the central heating system will be turned on and turned off. Setting the timer typically requires the user to sit at the controller and program the system using what is typically a fairly basic programming means. A system in which a user was able to program the system from a computer, which may or may not be physically connected to the central heating system, could significantly improve the flexibility of the programming system. For example, the timer could be set to turn on and off at different times each day, and holiday settings, in which the heating system is only turned on for brief periods, could be set. Further, the ability to remotely control the heating system would allow a user to re-program the controller without being sat at the controller itself.

Many so-called “white goods”, such as washing machines, freezers and microwave ovens could benefit from increased access to configuration settings and data. In particular, a service engineer could be given access to control systems within the devices, for example to allow updates and software fixes to be readily implemented. Access could also be given to service manuals, installation notes, service history notes, and usage information. In the case of washing machines and dishwashers, washing cycles could be modified. Giving remote access to such information could enable a service engineer to identify a problem without visiting the user. Giving the end-user information such as service information and installation notes may enable the end-user to carry out tasks that would previously have required a service engineer to be present.

Devices such as televisions, video cassette players (VCRs), digital versatile disk (DVD) players and the like could benefit from improvement setup and configuration options, increased data display during use and access to service information, including circuit schematics. Many such systems allow one of a number of sound settings to be selected: many users would like to be able to modify the settings of such sound settings; further, manufacturers that develop new sound settings would like to be able to give end-users the opportunity to incorporate the new sound settings into their existing equipment. Further, the development of such sound settings would be made easier if development engineers had a simple means for amending such settings. It is therefore clear that it would be advantageous to enable development engineers, service engineers and end-users ready access to such settings.

Clearly, the examples given above are just some of many applications where improved access to configuration and set-up details and ready access to maintenance and service data would be useful. It should be noted that allowing such devices to be re-configured as the technology is developed may extend the working life of such products as it may become possible to re-programme such devices to obtain increased functionality, rather than simply buying a replacement product.

Some schemes for addressing the issues identified above have been developed.

Consider the example of a central heating system that a user would like to connect to a computer system in order to make use of the familiar functionality of the computer in order to control the central heating system. It may not be necessary to connect the central heating system to the computer permanently; rather an occasional connection might be more appropriate.

An external device that is occasionally required to be connected to a host computer is often connected using a USB (Universal Serial Bus) connection. Thus, the central heating system in the example above could simply be connected to a laptop computer via a USB connection. The host laptop would recognize the presence of the central heating system and assign that device an address. The host laptop would then be able to communicate with the central heating system.

A USB connection is extremely simple to use: an end-user or service engineer would have no difficulty in setting up such a connection. The user would then be able to make use of software on the host computer to communicate with the central heating system, for example to program the central heating system, to analyse service-related data, or to review service information that is stored at the central heating system.

An alternative means of connecting an external device, such as a central heating system, to a computer, is to make use of the well-known TCP/IP protocol. In this system, the central heating system is assigned an address, and the computer is able to communicate with the central heating system via the Internet, in a well established manner.

In order for a system, such as a central heating system, to make use of the either the USB protocol or the TCP/IP protocol, the system must have a ROM that includes a suitable permanent boot code. Typically, USB systems require a 12 Kb permanent boot code and TCP/IP controller systems require a 20 Kb boot code. Clearly, the ROM memory space has other demands. The ROM must, for example, contain code implementing a filing system (such as the well-known File Allocation System (FAT)). Further the ROM is also required to store other data, such as data relating to applications implemented by the ROMs and configuration data. Accordingly, the overall size of the ROMs needs to be significantly larger than the 12 Kb and 20 Kb of the boot code. Typical minimum recommended sizes are at least 128 Kb for USB devices and at least 256 Kb for TCP/IP enabled systems.

Many products of the type for which the invention is suitable are not typically provided with ROMs of this size. Indeed, the provision of such ROMs may be prohibitively expensive.

ROMs are typically used to store the kind of configuration data and application programs described above. There are a number of forms of ROM. MASK-ROM (MROM) is a form of ROM whose contents are programmed by the IC manufacturer. MROM is ideal when high volume production is required and there can be reasonable certainty that the design will not change. Data in an MROM cannot, however, be edited or erased. Electrically Erasable Programmable ROM (EEPROM) is a form of ROM that can be electrically erased and then re-programmed. EEPROMs are typically re-programmed a byte at a time, which makes them versatile but slow. Flash memory is a type of EEPROM that enables the entire memory, or blocks of the memory, to erased and then re-programmed. For example, some flash memory devices enable chunks of 512 bytes to be reprogrammed at a time.

A typical application of flash memory is as a replacement for MASK-ROM (MROM). Flash memory is typically used in the development stage and is also often used in finished products, due largely to the flexibility that it offers when compared with MROM. Flash memory is typically chosen over MROM for its flexibility, but the inventor has noticed that the inherent re-programmability of the flash memory is not currently being exploited.

The flash memory used for storing configuration data and the like used in the applications described above is typically very small, perhaps 16 Kb, or even less. Accordingly, if connection of the memory to a host computer is required, the USB and TCP/IP connection systems described above that require permanent boot code are not practical, particularly if a significant amount of data storage is also required.

The device and method of the invention seek to address at least some of the problems associated with the prior art systems and/or to provide alternatives to the devices and methods of the prior art.

### SUMMARY

The invention provides an integrated microcontroller on-chip memory comprising first, second and third portions, wherein:
the memory is erasable non-volatile memory;
the first portion contains re-connection stub code for connecting the memory to a host computer when the memory is connected to the host computer either via a serial port of the host computer or via a connection media that mimics a serial port;
the second portion contains application code; and
the third portion contains data that is accessible to said host computer when the host computer is connected to the memory.

According to another aspect of the invention there is provided a method of enabling another microcontroller to gain shared access to an integrated microcontroller on-chip memory via a connection that mimics a serial port, wherein:
the memory is erasable non-volatile memory; and
the on-chip memory comprises:
   a first portion containing re-connection stub code for connection of the memory to the host computer;
   a second portion containing application code; and
   a third portion containing data that can be viewed by the host computer.

The invention also provides a method of enabling a host computer to gain access to an integrated microcontroller on-chip memory either via a serial port of the host computer or via a connection that mimics a serial port, wherein:
the memory is erasable non-volatile memory; and
the on-chip memory comprises:
   a first portion containing re-connection stub code for connection of the memory to the host computer;
   a second portion containing application code; and
   a third portion containing data that can be viewed by the host computer.

The application code defines one or more applications intended to be executed by the microcontroller with which the memory is integrated.

The connection media is preferably a UART, SPI, 12C or equivalent serial interface.

In a preferred embodiment, the reconnection means contained in the first portion of the on-chip memory is an integral boot-strap loader firmware mechanism.

In a another embodiment the microcontroller is enabled to open, read and write files on the native host PC filing system, or the another microcontroller.

For internet browser use, the ability to request a file path extension that does not actually exist, allows commands to be passed down to the embedded command handler to cause actions or control events on the embedded target device to be immediately executed.

The invention gives end-users, service engineers and software engineers access to the on-chip memory of products, such as consumer electronic products. In this way it is possible to reprogram or reconfigured such products.

The memory may be electrically erasable programmable Read-Only Memory.

In one form of the invention, the memory is flash memory. Some of the prior art suggests that the problems addressed by the invention can be addressed by connecting the embedded memory device to the host computer using a standard USB connection. Such a solution precludes the use of small, cheap flash memories. Such solutions are therefore relatively expensive. That expense is likely to prohibit the adoption of such technology in many cases.

In a preferred embodiment of the invention, the re-connection stub code is essentially permanent ROM memory. Thus, although other parts of the memory may be edited and/or erased, the boot stub generally cannot.

The application code contained within the second portion may be semi-permanent. The user may be able to amend the application code but, generally speaking, this function will not often be required. It is noted that a development engineer is more likely to have a need to amend this data that an end-user. It is possible, however, that an end-user might change this code by carrying out a upgrade.

The data contained within the third portion may be erasable and re-writable under the control of the host computer. This is the portion of the memory that is most likely to be amended by a user. Data files, configuration information and use logs are all likely to be stored here.

For added security against illegal downloads, the firmware update data may be encrypted with an electronic signature that only the target micro can unscramble and validate, before deciding to execute or not.

In one form of the invention, the first portion has a size of equal to or less than 1.5 Kb. In one form of the invention, the memory has a total size equal to 16 Kb or less, however, the invention is applicable to a wide range of memory sizes.

A filing system may be contained within the memory.

The re-connection stub code may contain code that enables the memory to appear as a conventional drive when viewed from the host computer. In one form of the invention, the memory appears as a conventional drive through a Windows™ driver. If the memory appears to the end-user in the same manner as a conventional drive, then the end-user is able to edit files stored in the memory with confidence since such an arrangement is familiar to almost all computer users. It is also noted that if the host computer is internet-enabled, the embedded memory can itself be connected to the internet by simply specifying the drive as it appears to the host computer as a shared drive. This provides a very simple means for giving remote third party read and/or write access to the embedded memory. This might be particularly useful if the remote third party is a service engineer.

The re-connection stub code may be run in response to a reset instruction. As noted above, some of the prior art suggests that the problems addressed by the invention can be addressed by connecting the embedded memory to the host computer using a standard USB connection. However, in some forms of the invention, the memory device has a size such that connection of the host computer to the memory via a USB connection is not appropriate. For example, if the memory device has a size of the order of 8 Kb, implementing a USB connection that requires a boot stub size of 12 Kb would not be possible. Similarly, in some forms of the invention, the memory has a size such that connection of the host computer to the memory device via a TCP/IP connection is not appropriate. The memory may be connectable to the host computer via a Universal Asynchronous Receiver,Transmitter (UART).

### BRIEF DESCRIPTION OF THE DRAWINGS

A device and method in accordance with the invention are described, by way of example only, with reference to the accompanying drawings in which:

FIG. 1 is a block diagram showing a system in which the invention is used;

FIG. 2 shows a memory map for a typical small flash memory device in accordance with the invention.

### DETAILED DESCRIPTION OF EMBODIMENTS

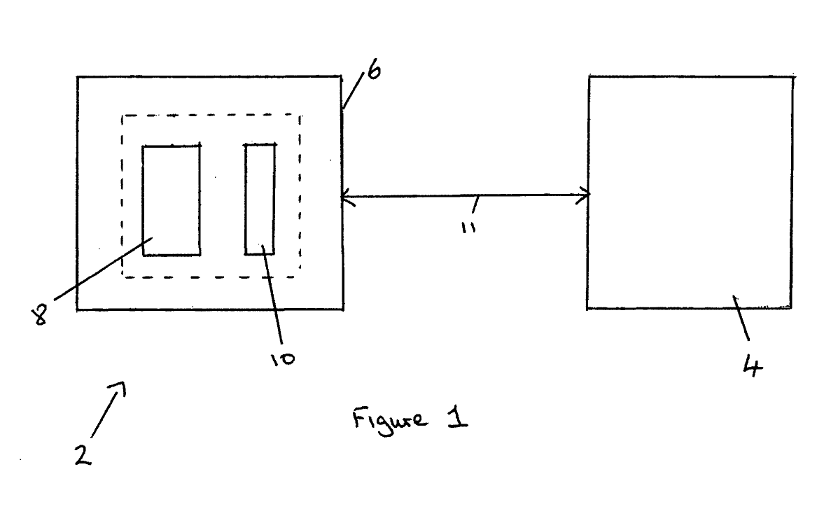

FIG. 1 is a block diagram showing a system, indicated generally by the reference numeral 2, in which the invention is used. The system 2 comprises a host computer 4 that is connected to a product 6 that includes a microcontroller 8 having an integrated on-chip memory 10.

The product 6 might, for example, be an industrial machine, a consumer electrical product, such as a washing machine, a piece of telecommunications equipment or an automotive product. The system 2 can be used to give the host computer 4 access to the memory 10 that is integrated with the microcontroller 8. As noted above, such a connection could be made using a USB connection. However, if the on-chip memory 10 has a very small capacity, this is either impractical or impossible due to the large amount of memory required by the required boot stub and filing system.

The invention, as illustrated in FIG. 1, makes use of a serial connection 11 between the host computer 4 and the product 6. For example, the serial connection 11 could use the well-known RS-232 protocol.

The RS-232 protocol, and similar serial connection protocols, are very simple and do not require a large boot stub in order to make a connection between the host computer 4 and the memory 10 of the product 6.

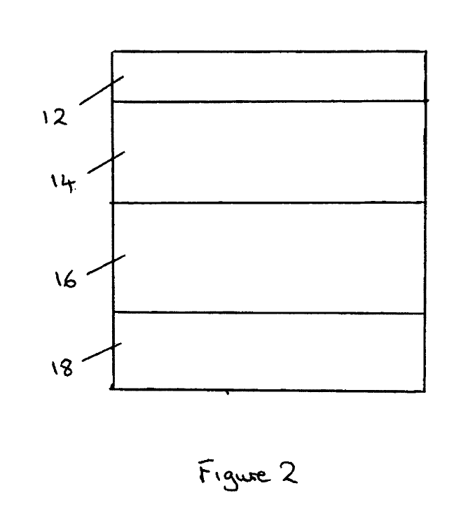

FIG. 2 shows a memory map for a typical small flash memory device suitable for implementing the on-chip memory 10. The memory map shows a small re-connection stub portion 12, an application portion 14, a data portion 16, and an unused portion 18.

The stub is essentially permanent. The application portion 14 contains the code for the application implemented by the flash memory: this is likely to be semi-permanent in the sense that it can be erased and/or edited (for example by a development engineer) but, in general, it is not often changed, particular when the product is in the field. The data portion 16 contains the data that is likely to be changed under the control of the host computer 4. The data section may, for example, include configuration information.

When the host computer 4 is connected to the product 6 via the serial connection 11, the re-connection stub portion 12 is run in response to a reset instruction. The purpose of the re-connection stub 12 is simply to provide a connection between the flash memory device and a host computer via a serial port. When connected, the flash memory appears as a drive on the host computer in a manner that will be familiar to all computer users (for example, by making use of a Windows™ driver). The host computer is then able to view data stored on the flash memory and is able to write data to the data portion 16. Indeed, reading and writing files to/from the flash memory device from the host computer is achieved in the same way as files are read from and written to the hard drive of any PC.

Thus, flash memory is provided that can be connected to the serial port of a host computer, perhaps on an occasional basis, for example by a service engineer or an end-user. The flash memory then appears as a drive of the PC. Thus, an end-user or a service engineer can connect a PC to the product (e.g. a washing machine, or a conveyor-belt controller in an industrial plant) and gain access to the information stored in the on-chip flash memory.

The inventor has realized that the re-connection stub 12 can be simple because the connection need only be tailored to the specific connection that it needs to make, i.e. a simple connection to a host computer via a serial link. There is no reason for generality of the type typically provided, for example, by a USB boot stub. This, in addition to the simple nature of the RS-232 connection protocol, means that the re-connection stub 12 can be made small enough for use with even very small flash memories.

The invention has been implemented using an MSP430 flash microcontroller unit (MCU) available from Texas Instruments Incorporated. A re-connection stub code has been written having a size of 1.2 Kb. The memory of the MSP430 flash MCU can be erased in 512 byte blocks. Accordingly, the 1.2 Kb stub code requires three such blocks (i.e. 1.5 Kb). The remainder of the flash MCU memory is therefore available for the application code and data of the flash memory. Thus, it is possible to use this implementation of the invention with flash products having memory sizes as small as 2 Kb.

Although the use of the invention has been described in conjunction with a serial connection, this is not essential. Any more complicated connection system (such as a USB connection) can be made to mimic a simple serial connection (such as an RS-232 connection). If a USB connection is used, a USB-to-serial converter can be used so that the connection mimics a serial connection. It should be noted that virtually all connection systems with which a user might wish to use the invention are able to mimic a simple serial connection protocol.

The following are a number of example applications of aspects of the invention.

Consider a fire alarm system in which a number of sensors, including smoke and heat sensors are placed in a number of rooms in a residential property. Each sensor can be provided with flash memory of the form shown in FIG. 2 that can be connected to a host computer by connecting that sensor to the serial port of the host computer and resetting the sensor so that the flash memory executes the re-connection stub 12. The flash memory may contain a variety of information, such as installation information, that can be viewed by the end-user. In order to distinguish between different types of incident, the user may be given the chance to record a message that can be stored as data on the flash memory device and played in the event that a particular event is detected. By way of example, the user might record the messages “Fire in living room”, “Fire in the kitchen” and “Fire in master bedroom” for replay if any of those events are determined. A log of the alarm history might be kept locally in the data portion 16 of the flash memory device, with that history being downloadable by the host computer.

The controller for a central heating system may include a flash memory of the form shown in FIG. 2 that can be connected to a host computer via the serial port of the host computer. The flash memory can be provided with a simple data file stored in the data portion 16 specifying on and off times for the heating system, which can be changed by the user by simply editing the appropriate data file stored on the flash memory. This form of editing is familiar to computer users. The flash memory can also be provided with installation details of use to an engineer when installing the system, again with those details being stored in the data portion 16. The installation details may be editable to reflect the particular installation so that a maintenance engineer can be made aware of particular features of the installation.

Many commodities, such as electricity, gas and water, are sold on a metered basis. For example, a residential electricity meter measures the amount of electricity used. A meter reading must be taken to determine the amount of electricity used and therefore the charge to be made to the user.

In accordance with the invention, the meter can be connected to a serial port of a host computer and the host computer can gain access to the data stored in the memory of the meter. This data can then be transmitted to the relevant electricity supplier in order for a bill to be calculated. The data may, for example, be transmitted via email, which email could, for example, be automatically generated by a program executed by the host computer. Alternatively, the host computer may designate that the relevant folder on the flash memory is a “shared” folder, so that the electricity company can remotely access the data within that folder, in a manner that is well known in the art. Of course, some form of password protection or other access control may be required. The host computer in this example may be that of a meter reader who visits the meter. Alternatively, the host computer could be that of an end-user collecting data on behalf of the electricity supplier.

Alternatively, or in addition, data relating to electricity tariffs could be uploaded to the meter and/or to the host computer, thereby enabling the meter and/or the host computer to determine the electricity bill.

Man y supermarkets provide scales for weighing fruit and vegetables that allow the user to indicate the item being weighed and print a ticket indicating the price of goods on the basis of the identity of the selected goods, the measured weight of the selected goods and the unit price of those goods. Clearly, such a device must be updated as the prices of goods change. Also, as the product range changes, the display allowing the user to select the product being weighed will need to be updated. It would be convenient for the supermarkets, which may have a large number of identical machines, to be able to update the machines quickly, easily and remotely. This can be achieved by providing a flash memory with the application software required to communicate the product range to the customer and to supply the flash memory with the data required to calculate the correct price.

The proc ess of updating the flash memory of such devices could be automated so that the devices could be updated at the same time.

Medical instruments could be provided to a patient for home use. The medical instruments could be connected to a host computer at the patient's home. Patient data, such as blood pressure, blood glucose levels and body temperature could be stored on flash memory and, on connection of the instruments to the host computer, uploaded into a format (e.g. a spreadsheet) for sending to a doctor, for example by email. This process would enable patient data to be sent to a doctor, without requiring the patient to interpret the readings of any of the medical instruments.

An industrial plant may have a controller for controlling various machines within the plant. If a motor within the plant is changed to a motor having different characteristics, the controller may need to be modified. If the controller program is stored on a flash memory and external access is given to that flash memory, then the controller can be easily modified to function correctly with the new motor.

A number of example applications of the invention have been described herein. It should be noted that the invention is not limited to use in the described example embodiments. The skilled person will be aware of many additional applications to which the invention is applicable. Moreover, those skilled in the art to which the invention relates will appreciate that various additions, deletions, substitutions and other modifications may be made to the described embodiments, without departing from the scope of the claimed invention.

1. An integrated microcontroller on-chip memory comprising first, second and third portions, wherein:
the memory is erasable non-volatile memory;
the first portion contains re-connection stub code for connecting the memory to a host computer when the memory is connected to the host computer either via a serial port of the host computer or via a connection media that mimics a serial port;
the second portion contains application code; and
the third portion contains data that is accessible to said host computer when the host computer is connected to the memory.

2. An integrated microcontroller on-chip memory as claimed in claim 1, wherein the memory is electrically erasable programmable Read-Only Memory.

3. An integrated microcontroller on-chip memory as claimed in claim 1, wherein the memory is flash memory.

4. An integrated microcontroller on-chip memory as claimed in claim 1, wherein the re-connection stub code is substantially permanent.

5. An integrated microcontroller on-chip memory as claimed in claim 1, wherein the application code contained within the second portion is semi-permanent.

6. An integrated microcontroller on-chip memory as claimed in claim 1, wherein the data contained within the third portion is erasable and re-writable under the control of the host computer.

7. An integrated microcontroller on-chip memory as claimed in claim 1, wherein the first portion has a size of equal to or less than 1.5 Kb.

8. An integrated microcontroller on-chip memory as claimed in claim 7, wherein the re-connection stub code has a size of 1.2 kb or less.

9. An integrated microcontroller on-chip memory as claimed in claim 1, wherein a filing system is contained within the memory.

10. An integrated microcontroller on-chip memory as claimed in claim 1, wherein the re-connection stub code contains code that enables the memory to appear as a conventional drive when viewed from the host computer.

11. An integrated microcontroller on-chip memory as claimed in claim 1, wherein the re-connection stub code is run in response to a reset instruction.

12. An integrated microcontroller on-chip memory as claimed in claim 1, wherein the memory is connectable to the host computer via a Universal Asynchronous Receiver/Transmitter.

13. An integrated microcontroller on-chip memory as claimed in claim 1, wherein the microcontroller on-chip memory has a size of 16 kb or less.

14. An integrated microcontroller on-chip memory as claimed in claim 13, wherein the microcontroller on-chip memory has a size of 2 kb or less.

15. A method of enabling a host computer to gain access to an integrated microcontroller on-chip memory either via a serial port of the host computer or via a connection that mimics a serial port, wherein:
the memory is erasable non-volatile memory; and
the on-chip memory comprises:
a first portion containing re-connection stub code for connection of the memory to the host computer;
a second portion containing application code; and
a third portion containing data that can be viewed by the host computer.

16. A method as claimed in claim 15, wherein the data contained within the third portion is erasable and re-writable under the control of the host computer.

17. A method as claimed in claim 15, wherein the re-connection stub code contains code that enables the memory to appear as a conventional drive when viewed from the host computer.

18. A method as claimed in any one of claims 15, wherein the re-connection stub code is run in response to a reset instruction.

19. A method as claimed in any one of claims 15, wherein the memory is connectable to the host computer via a Universal Asynchronous Receiver/Transmitter (UART).

20. An integrated microcontroller on-chip memory comprising first, second and third portions, wherein:
the memory is erasable non-volatile memory;
the first portion contains re-connection stub code for connecting the memory to a host computer when the memory is connected to the host computer either via a serial port of the host computer or via a connection media that mimics a serial port;
the second portion contains application code; and
the third portion contains data that is accessible to said host computer when the host computer is connected to the memory;
wherein the re-connection stub code is substantially permanent;
wherein the application code contained within the second portion is semi-permanent;
wherein the data contained within the third portion is erasable and re-writable under the control of the host computer;
wherein the re-connection stub code has a size of 1.2 kb or less;
wherein a filing system is contained within the memory;
wherein the re-connection stub code contains code that enables the memory to appear as a conventional drive when viewed from the host computer; and
wherein the re-connection stub code is run in response to a reset instruction.
